(19) United States
(12) Patent Application Publication
(10) Pub. No.: US 2007/0169076 A1
(43) Pub. Date: Jul. 19, 2007

(54) Methods and systems for updating a BIOS image

(76) Inventors: Bernard D. Desselle, Spring, TX (US); Timothy N. McDonough, Tomball, TX (US); Christoph J. Graham, Houston, TX (US); William R. Jacobs, Houston, TX (US); Louis B. Hobson, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/261,101

(22) Filed: Oct. 28, 2005

(51) Int. Cl. G06F 9/44

(52) U.S. Cl. 717/168

(57) ABSTRACT

In at least some embodiments, a computer system comprises a processor and a system memory coupled to the processor. The system memory stores a multi-platform management interface that, when executed, enables communication between the computer system and an updating computer. The computer system further comprises a Basic Input/Output System (BIOS) memory coupled to the processor, the BIOS memory stores a BIOS image and function calls compatible with the multi-platform management interface, wherein at least one of the function calls is selectively initiated to update the BIOS image based on communication with the updating computer via the multi-platform management interface.

### BACKGROUND

A BIOS (Basic Input/Output System) is the lowest-level software in a computer and acts as an interface between the computer's hardware (e.g., a chipset and a processor) and the computer's operating system. The BIOS supports several functions such as enabling a user to change a computer's hardware settings and “booting” a computer when a power button or reset button is activated.

In some cases, upgrading (i.e., updating) the BIOS is desirable. For example, a BIOS may be updated to fix software “bugs” or to enhance functions supported by the BIOS. One existing method to update a BIOS requires modifying the BIOS configuration settings to interface with a server and setting up the server to boot to the computer whose BIOS is being updated. This method also requires rebooting the computer a plurality of times. Another existing method uses an interrupt (INT 15) to update the BIOS from the computer's operating system. This method requires installation of an application that calls the interrupt routines of the BIOS and may require drivers to handle the update request. Preparing and distributing drivers to handle BIOS upgrade requests for different computer platforms is time-consuming and costly. Also, current drivers and BIOS code only support 16-bit and 32-bit computer systems.

### BRIEF DESCRIPTION OF THE DRAWINGS

For a detailed description of exemplary embodiments of the invention, reference will now be made to the accompanying drawings in which:

FIG. 1 shows a system in accordance with embodiments of the invention;

FIG. 2 shows an interaction of computer-based software elements in accordance with embodiments of the invention;

FIG. 3 shows a method in accordance with embodiments of the invention;

FIG. 4 shows another method in accordance with alternative embodiments of the invention; and

FIG. 5 show another method in accordance with alternative embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments of the invention are configured to update a computer system's Basic Input/Output System (BIOS). In at least some embodiments, the BIOS is updated using a multi-platform management interface such as a Web-Based Enterprise Management (WBEM) interface. A multi-platform management interface such as a WBEM interface comprises a set of computer management and Internet standard technologies that facilitate the exchange of data between different computer platforms. For example, some Windows® operating systems implement a WBEM-based component known as the Windows Management Instrumentation (WMI). In such embodiments, WMI function calls stored in the BIOS memory are able to allocate a portion of the computer system's memory for storage of the BIOS image update and/or to manage transferring the BIOS image update to a portion of the computer system's memory. After the BIOS image update is stored in the computer system's memory, a routine such as a System Management Interrupt (SMI) routine is implemented to overwrite the current BIOS image with the BIOS image update (a process sometimes referred to as “flashing”). Subsequently, the portion of the computer system's memory that stores the BIOS image update is free to store other data.

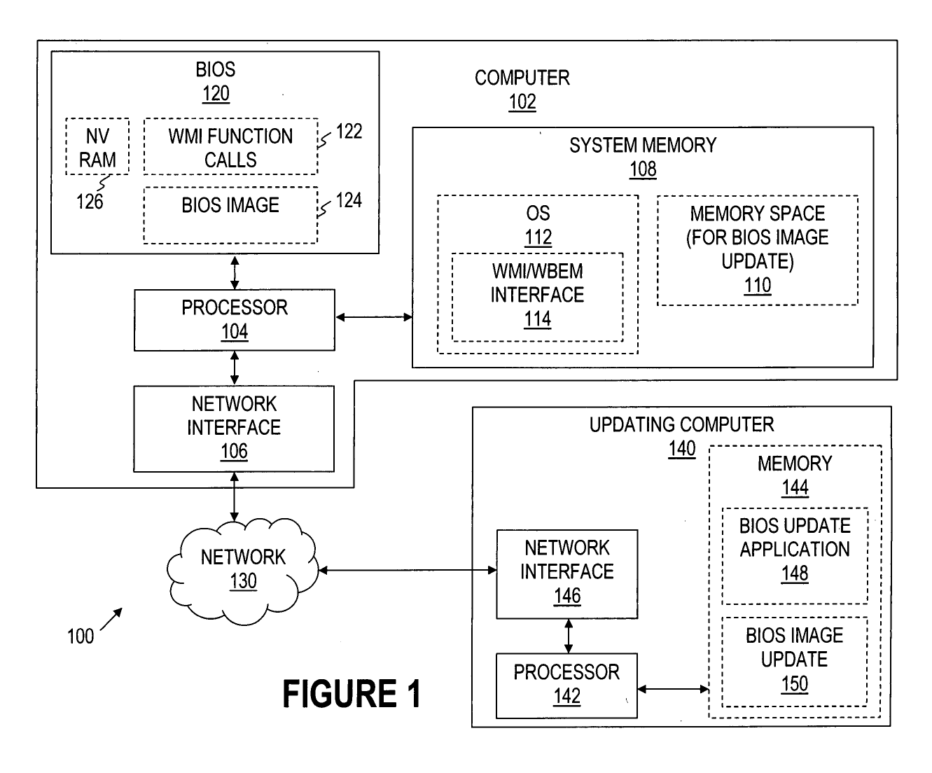

FIG. 1 shows a system 100 in accordance with embodiments of the invention. As shown in FIG. 1, the system 100 comprises a computer 102 coupled to an updating computer 140 via a network 130. The updating computer 140 may be located remotely or locally to the computer 102. The updating computer 140 is configured to transfer a BIOS image update 150 to the computer 102 whereby the computer 102 updates its BIOS image 124 as will be described in further detail below.

As shown, the computer 102 comprises a processor 104 coupled to a system memory 108. The system memory 108 stores an operating system (OS) 112 having a WMI/WBEM interface 114. The system memory 108 also provides memory space 110 that is configurable to store the BIOS image update 150 previously mentioned. As shown, the processor 104 couples to a network interface 106 as well as a BIOS 120 having WMI function calls 122 and the BIOS image 124. The BIOS image 124 enables BIOS functions such as interfacing between hardware and higher-level applications (e.g., an operating system). Also, the BIOS image 124 is “flashable” (i.e., the BIOS image 124 may be overwritten with a new BIOS image) and may include the WMI function calls 122. The computer 102 also may comprise other components such as logic bridges (e.g., North bridge and South bridge), communication busses, peripheral devices (e.g., monitor or printer) or input devices (e.g., keyboard and mouse), which are not shown for convenience.

The updating computer 140 comprises a processor 142 coupled to a memory 144 having a BIOS update application 148 and a BIOS image update 150. The updating computer 140 also comprises a network interface 146 that enables communication with the computer 102 via the network 130 which may be a local area network (LAN), an Internet-based network or another network. Although other techniques may be possible, there are presented herein three techniques that enable the BIOS image update 150 to be transferred from the updating computer 140 to the system memory 108. After being stored in the system memory 108, the BIOS image update 150 can be used to update the BIOS image 124. The three techniques are compatible with existing WBEM-capable computer systems and use the WMI function calls 122 stored in the BIOS 120.

In the first technique, the memory space 110 is reserved for storing the BIOS image update 150 during each boot cycle. Thus, the size of the memory space 110 is configured to be equal to or greater than the size of the BIOS image update 150. In some embodiments, the memory space 110 is reserved during each Power On Self-Test (POST) of the computer 102 through an interrupt routine such as “INT 15 E820.” During an INT 15 E820 routine, the BIOS image 124 provides a memory map to the operating system 112 such that the operating system 112 reserves the memory space 110 for the BIOS image update 150. Alternatively, the memory space 110 is reserved through an operation region (i.e., a contiguous block of memory) defined by the computer's Advanced Configuration and Power Interface (ACPI) code.

Subsequent to the memory space 110 being reserved for storing the BIOS update image 150, the BIOS update application 148 is executed by the processor 142 of the updating computer 140. For example, an administrator or user of the computer 102 and/or the updating computer 140 may choose to execute the BIOS update application 148 if a BIOS image update 150 is available (e.g., a BIOS image update 150 may fix software “bugs” or enhance the functionality of the BIOS). When executed, the BIOS update application 148 uses the WMI/WBEM interface 114 of the computer's operating system 112 to submit a request to update (flash) the BIOS image 124. The request is submitted to the BIOS 120, which may proceed with the request, deny the request or require authentication (e.g., a password) before proceeding with the request. In some embodiments, the BIOS update application 148 passes information related to the request (e.g., the data block size to be buffered, the total image size or an administrator's password) to the WMI/WBEM interface 114. The WMI/WBEM interface 114 may use this information to carry out the request or to authenticate the request to update the BIOS 120.

If the BIOS 120 proceeds with the request, one or more WMI function calls 122 stored in the BIOS 120 is operable to handle the request. A WMI function call handles the request by initiating an ACPI method. For example, each of the WMI function calls 122 may be associated with an ACPI method based on an ACPI mapper driver. Thus, if a WMI function call is initiated, the ACPI mapper driver locates an identifier (e.g., a globally unique identifier or “GUID”) of the WMI function call. Thereafter, the ACPI mapper driver locates the ACPI method that has been associated with the identifier of the WMI function call. For more information regarding WMI, WBEM or ACPI, reference may be made to U.S. patent application Ser. No. 11/058,341, entitled “Method And Apparatus For Controlling Operating System Access To Configuration Settings,” filed Feb. 15, 2005 and herein incorporated by reference as if reproduced in full below.

In at least some embodiments, the WMI function call that is initiated in response to the request to update the BIOS image 124 calls an ACPI method that buffers data received via the WMI/WBEM interface 114 into the memory space 110. For example, if the BIOS image update 150 comprises a 1 megabyte (MB) image, the image may be buffered into the memory space 110 by transferring 4 Kilobyte (KB) blocks of data at a time. The ACPI method also validates the blocks of data (i.e., the image) being buffered into the memory space 110. After the validity of each block of data is checked, a success code (e.g., an acknowledgement code or “ACK” code) or an error code (e.g., a non-acknowledgement code or “NAK” code) is returned to the WMI/WBEM interface 112.

The WMI function calls 122 stored in the BIOS 120 cause the BIOS image update 150 to be buffered to the memory space 110 until a determination is made that the entire BIOS image update 150 has been buffered and is valid or until a failure occurs. For example, a failure may occur if more than a threshold amount of time has passed during the buffering process or if more than a threshold number of attempts to buffer the BIOS image update 150 is reached. If the entire BIOS update image is buffered and valid, a SMI routine is generated within the ACPI method to update (flash) the BIOS image 124.

In the second technique, the memory space 110 is not reserved for storing the BIOS image update 150 during each boot cycle. Instead, the process of reserving the memory space 110 occurs after a request to update (flash) the BIOS image 124 has occurred. In the second technique, an administrator or user of the computer 102 and/or the updating computer 140 may choose to execute the BIOS update application 148 if a BIOS image update 150 is available. When executed, the BIOS update application 148 uses the WMI/WBEM interface 114 of the computer's operating system 112 to submit a request to update (flash) the BIOS image 124. The request is submitted to the BIOS 120, which may proceed with the request, deny the request or require authentication (e.g., a password) before proceeding with the request. In some embodiments, the BIOS update application 148 passes information related to the request (e.g., the data block size to be buffered, the total image size or an administrator's password) to the WMI/WBEM interface 114. The WMI/WBEM interface 114 may use this information to carry out the request or to authenticate the request to update the BIOS 120.

If the BIOS 120 proceeds with the request, one or more WMI function calls 122 stored in the BIOS 120 is operable to handle the request. A WMI function call handles the request by initiating an ACPI method. As previously described, each of the WMI function calls 122 may be associated with an ACPI method based on an ACPI mapper driver that correlates each WMI function with an ACPI method (e.g., by correlating identifiers such as GUIDs).

The ACPI method generates an SMI routine to enable updating the BIOS image 124. For example, in at least some embodiments, the SMI routine sets a flag in non-volatile memory (NVRAM) 126 of the BIOS 120 to indicate that upon subsequent boot, the memory space 110 needs to be reserved for storing the BIOS image update 150. Upon subsequent boot (e.g., during a POST), the memory space 110 is reserved using an interrupt (e.g., INT 15 E820) or through an operation region (i.e., a contiguous block of memory) defined by the computer's ACPI code. Also, the flag previously set in the NVRAM of the BIOS is cleared so that the memory space 110 is made available on the next boot of the computer 102.

After the memory space 110 is reserved, the computer 102 boots to the operating system 112 and the request to update the BIOS image 124 is processed using the WMI/WBEM interface 114. To process the request, one or more of the WMI function calls 122 stored in the BIOS 120 are initiated. The WMI function calls 122 correspond to an ACPI method that buffers data received via the WMI/WBEM interface 114 into the memory space 110. The BIOS image update 150 is therefore transferred from the updating computer 140 to the memory space 110 through the WMI/WBEM interface 114. As an example, if the BIOS image update 150 comprises a 1 megabyte (MB) image, the image may be buffered into the memory space 110 by transferring 4 Kilobyte (KB) blocks of data at a time. As previously described, the ACPI method also validates the blocks of data and transmits a code (that acknowledges a successful data transfer or an unsuccessful data transfer) to the WMI/WBEM interface 114. The WMI function calls 122 stored in the BIOS 120 cause the BIOS image update 150 to be buffered to the memory space 110 until a determination is made that the entire BIOS image update 150 has been buffered and is valid or until a failure occurs. If the entire BIOS image update is buffered and valid, a SMI routine is generated within the ACPI method to update (flash) the BIOS image 124.

In the third technique, an administrator or user of the computer 102 and/or the updating computer 140 may choose to execute the BIOS update application 148 if a BIOS image update 150 is available. When executed, the BIOS update application 148 uses the WMI/WBEM interface 114 of the computer's operating system 112 to submit a request to update (flash) the BIOS image 124. The request is submitted to the BIOS 120, which may proceed with the request, deny the request or require authentication (e.g., a password) before proceeding with the request. In some embodiments, the BIOS update application 148 passes information related to the request (e.g., the data block size to be buffered, the total image size or an administrator's password) to the WMI/WBEM interface 114.

If the BIOS 120 proceeds with the request, one or more WMI function calls 122 stored in the BIOS 120 is operable to handle the request. A WMI function call handles the request by initiating a corresponding ACPI method. In the third technique, the ACPI method sends a request to the operating system 112 to hot unplug the memory space 110 from the system memory 108 (i.e., the operating system 112 is configured to ignore the memory space 110 as if it has been removed from the computer's system memory 108). The size of the hot unplugged memory space 110 is equal to or greater than the size of the BIOS image update 150. Thereafter, the operating system 112 does not recognize that the memory space 110 is accessible (due to the hot unplug request), but the WMI/WBEM interface 114 is able to buffer data to the memory space 110 based on instructions from the BIOS update application 148.

After the memory space 110 is reserved for the BIOS update process (using the virtual hot unplugging process), one or more of the WMI function calls 122 stored in the BIOS 120 are initiated. The WMI function calls 122 correspond to an ACPI method that buffers data received via the WMI/WBEM interface 114 into the hot unplugged memory space 110. The BIOS image update 150 is therefore transferred from the updating computer 140 to the memory space 110 through the WMI/WBEM interface 114. As previously described, the ACPI method also validates the blocks of data and transmits a code (that acknowledges a successful data transfer or an unsuccessful data transfer) to the WMI/WBEM interface 114. The WMI function calls 122 stored in the BIOS 120 cause the BIOS image update 150 to be buffered to the memory space 110 until a determination is made that the entire BIOS image update 150 has been buffered and is valid or until a failure occurs. If the entire BIOS update image is buffered and valid, a SMI routine is generated within the ACPI method to update (flash) the BIOS image 124.

After the BIOS image 124 has been updated (flashed), one of the WMI function calls 122 stored in the BIOS 120 is initiated to hot plug the memory space 110 into the system memory 108 (i.e., the operating system 112 is configured to recognize the memory space 110 as if it has been inserted into the computer's system memory 108). The memory space 110 is thereafter available for other uses (besides storing the BIOS update image 150).

The three techniques described above are compatible with existing WMI/WBEM-enabled computers. However, embodiments of the invention are not limited to WMI/WBEM-enabled computers. Rather, embodiments of the invention implement a multi-platform management interface such as WMI/WBEM that enables data exchanges across different computer platforms. The multi-platform management interface enables a computer to update the current BIOS image without installation of new routines (e.g., interrupt routings) and without reconfiguration. In other words, the ability to update the BIOS image using a multi-platform management interface that is compatible with various computer platforms is built into each BIOS and each computer's operating system by default.

In systems that implement WMI/WBEM, only the computer being updated need be WMI/WBEM-enabled. For example, the computer 102 may be WMI/WBEM-enabled while the updating computer 140 is not. In such embodiments, the updating computer 140 sends WMI commands to the WMI/WBEM-enabled computer 102 using an appropriate application such as Visual Basic Script.

In at least some embodiments, memory space of a computer is reserved every boot cycle for updating a BIOS image (e.g., as in the first technique). This eliminates accessing the memory space for other uses, but allows the BIOS image to be updated without re-booting. In alternative embodiments, memory space is reserved in response to a request to update the BIOS. For example, in the second technique, the memory space is reserved in the next boot cycle after the request to update the BIOS image is made. After the BIOS image is updated, the computer may be re-booted to free the memory space for other uses. In the third technique, the memory space is reserved in response to a request to update the BIOS. The memory space is reserved using a hot-unplugging technique (i.e., the memory space is virtually hot-unplugged from a system memory). After the BIOS image is updated, the memory space is made available for other uses (besides updating the BIOS image) using a hot-plugging technique (i.e., the memory space is virtually hot-plugged into a system memory). Thus, in the third technique, memory space is reserved for updating the BIOS image only as needed and without re-booting.

In FIG. 1, the BIOS update application 148 is described as being stored and executed by the updating computer 140. However, in alternative embodiments, the BIOS update application 148 could be stored and executed by the computer 102. In such embodiments, the BIOS image update 150 is still received from the updating computer 140 which may be a local computer or a remote computer (e.g., a server) coupled to the computer 102 via the network 130.

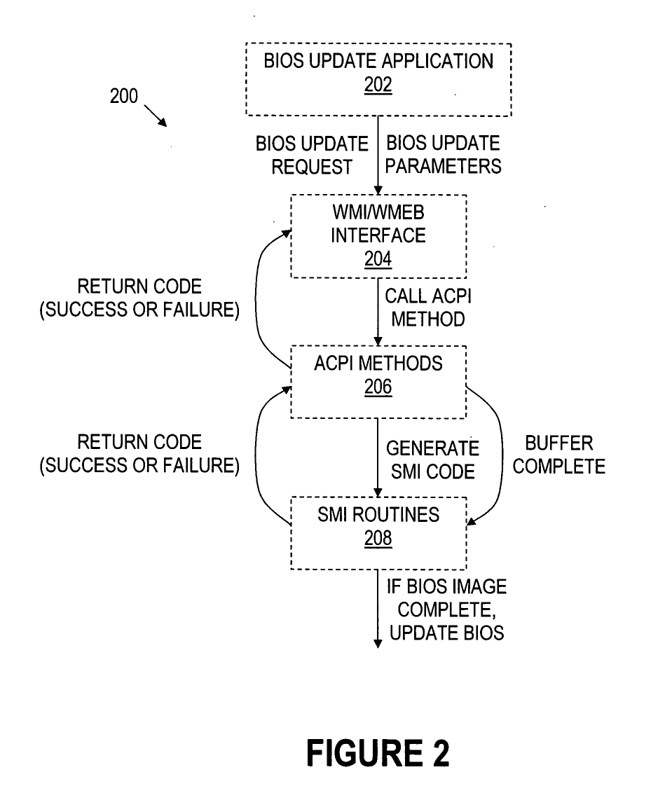

FIG. 2 shows an interaction 200 of computer-based software elements in accordance with embodiments of the invention. As shown, the software elements comprise a BIOS update application 202, a WMI/WBEM interface 204, ACPI methods 206 and SMI routines 208. In some embodiments (as in FIG. 1), the BIOS update application 202 is stored and executed on a first computer (e.g., the updating computer 140) while the WMI/WBEM interface 204, the ACPI methods 206 and the SMI routines 208 are stored and executed on a second computer (e.g., the computer 102 or the computer whose BIOS is to be updated). However, in alternative embodiments, the BIOS update application 202 could be stored and executed on the same computer as the other software elements (i.e., the computer 102 could store and execute all the software elements shown in FIG. 2). In such embodiments, the BIOS image update is still received from another local computer or remote computer (e.g., a server) via a network connection.

As shown in FIG. 2, the BIOS update application 202 sends a BIOS update request and BIOS update parameters (e.g., the data block size, the total image size or an administrator's password) to the WMI/WBEM interface 204. For example, the BIOS update application 202 may be selectively initiated by a user (causing the BIOS update request and the BIOS update parameters to be sent) if a BIOS image update is available. In response, the WMI/WBEM interface 204 calls corresponding ACPI methods 206 which handle buffering the BIOS image update to a reserved memory space. Once the buffering is complete, the ACPI methods 206 generate SMI routines 208 that update the current BIOS image. The ACPI methods 206 also may generate SMI routines 208 to enable/disable reserving memory space (as in the second technique described above).

As shown, the ACPI methods 206 are able to return codes to the WMI/WBEM interface 204 indicating successful or failed operations. Also, the SMI routines 208 are able to return codes to the ACPI methods 206 (and on to the WMI/WBEM interface 204 via the ACPI methods 206) indicating successful or failed operations. If necessary, the WMI/WBEM interface 204 is able to repeat the process of buffering the BIOS image update and flashing the BIOS image until the BIOS is successfully updated or until a predetermined amount of failures occurs (or until a predetermined amount of time passes).

Although embodiments of the invention have been described using standards such as SMI, ACPI, and WMI, other embodiments are possible. For example, SMIs are used by an OS (e.g., OS 112) or hardware to trigger an event that will halt the current operation and jump into BIOS code to handle an event/request. Alternatively, other user defined interrupts could be used to achieve the same results, but may not be as secure. ACPI provides a mechanism to make the SMI calls into the BIOS. Alternatively, ACPI could be bypassed by making INT calls directly to the BIOS, but drivers are needed to generate these calls and to perform other operations that would normally be performed by ACPI (e.g., memory hot plugging/unplugging). WMI provides a software interface with the ability to make calls into the ACPI. Alternatively, other software interfaces could be developed to make calls into the ACPI.

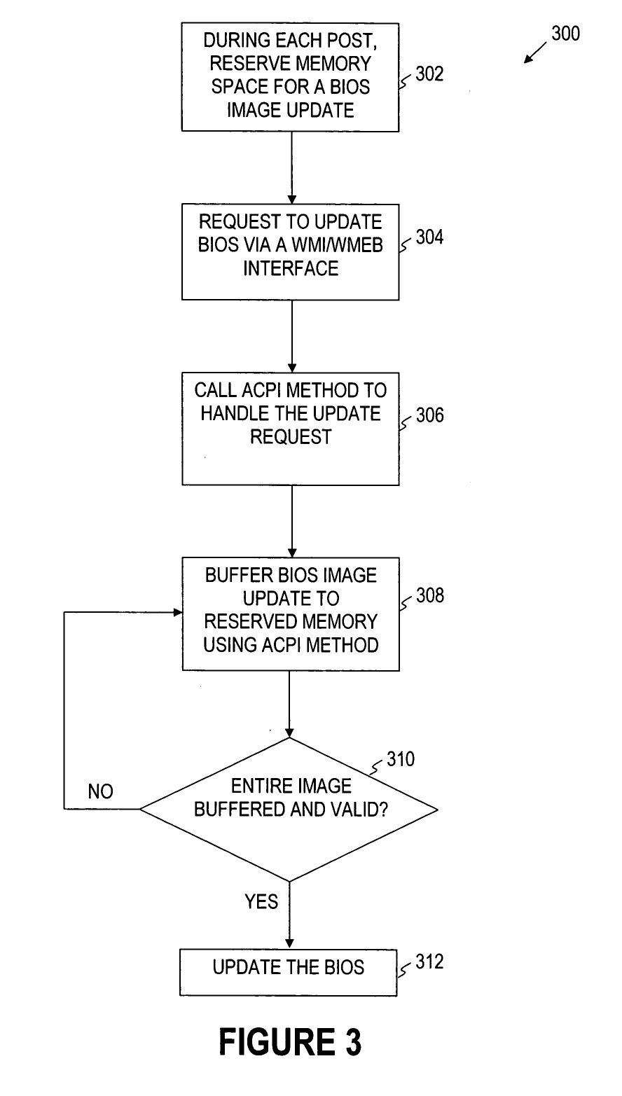

FIG. 3 shows a method 300 in accordance with embodiments of the invention. As shown in FIG. 3, the method 300 comprises, during each POST operation of a computer, reserving memory space for a BIOS image update (block 302). For example, the memory space may be reserved via an interrupt (e.g., an INT 15 E820 interrupt) or via an operation region defined by ACPI code. The method 300 continues by requesting to update a BIOS image via a WMI/WBEM interface (block 304). At block 306, an ACPI method is called to handle the update request. The ACPI method corresponds to a WMI function call, which may be stored in the BIOS. Using the ACPI method, a BIOS image update is buffered to the reserved memory (block 308). If the entire image update is buffered and valid (determination block 310), the BIOS is updated or “flashed” (block 312). Otherwise, the BIOS image update continues to be buffered using the ACPI method (block 308).

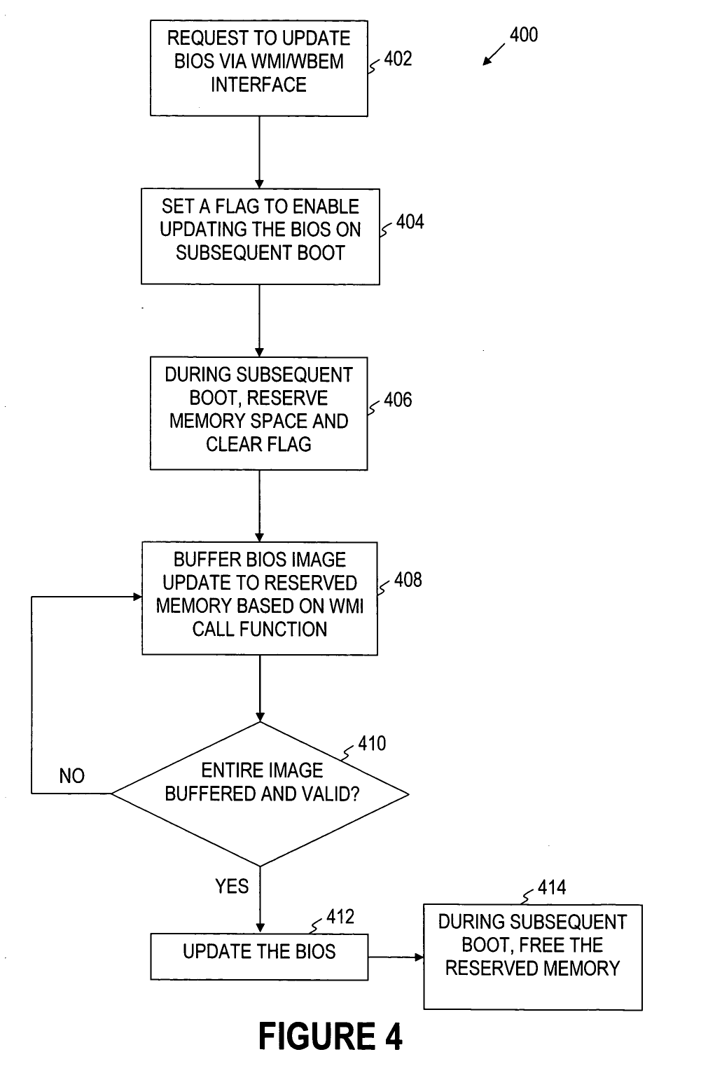

FIG. 4 shows another method 400 in accordance with alternative embodiments of the invention. As shown in FIG. 4, the method 400 comprises requesting to update a BIOS image via a WMI/WBEM interface (block 402). The method 400 continues by setting a flag to enable updating the BIOS image on the subsequent boot (block 404). In at least some embodiments, the flag is set in a non-volatile memory (NVRAM) of the BIOS. During the subsequent boot, memory space is reserved and the flag is cleared (block 406). As described previously, the memory space may be reserved via an interrupt (e.g., an INT 15 E820 interrupt) or via an operation region defined by ACPI code.

At block 408, the BIOS image update is buffered to the reserved memory based on a WMI function call. In at least some embodiments, the WMI function call is stored in the BIOS. If the entire BIOS image update is buffered and valid (determination block 410), the method 400 continues by updating or “flashing” the BIOS (block 412). If the entire BIOS image update is not buffered or is not valid (determination block 410), the BIOS image update continues to be buffered based on the WMI function call (block 408). During the subsequent boot (after the BIOS is updated), the reserved memory is freed (available) for other uses (block 414).

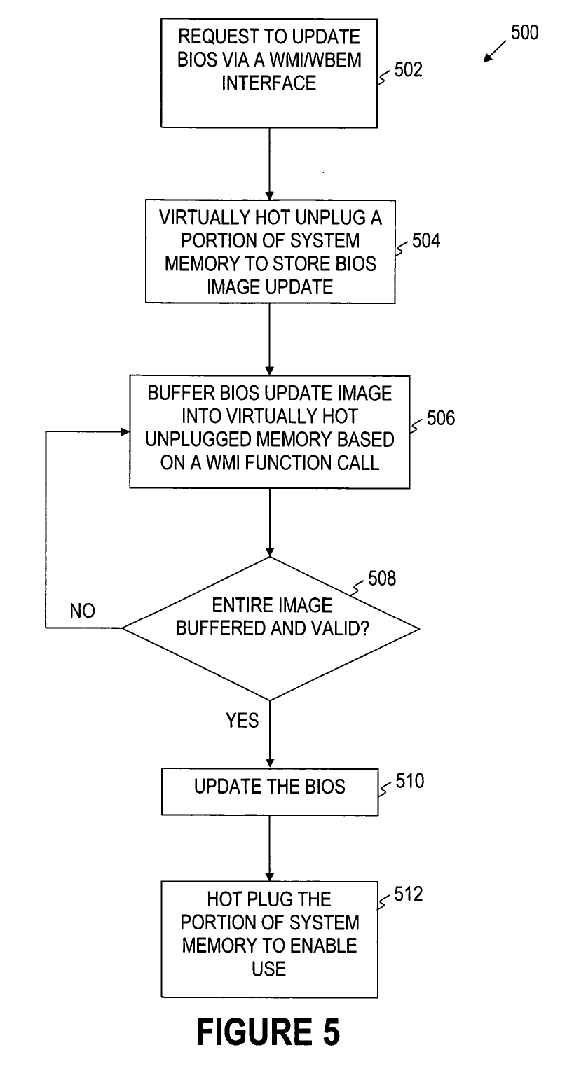

FIG. 5 shows another method 500 in accordance with alternative embodiments of the invention. As shown in FIG. 5, the method 500 comprises requesting to update a BIOS via a WMI/WBEM interface (block 502). At block 504, the method 500 virtually unplugs a portion of a system memory to store a BIOS image update. Thereafter, a BIOS image update is buffered into the virtually unplugged memory based on a WMI function call (block 506). If the entire BIOS image update is buffered and valid (determination block 508), the method 500 continues by updating or “flashing” the BIOS (block 510). Otherwise, the method 500 continues to buffer the BIOS image update into the virtually unplugged memory based on the WMI function call (block 506). After the BIOS is updated at block 510, the portion of the system memory that stored the BIOS image update is hot-plugged to “free up” or enable that portion of the system memory for other uses (block 512).

The above discussion is meant to be illustrative of the principles and various embodiments of the present invention. Numerous variations and modifications will become apparent to those skilled in the art once the above disclosure is fully appreciated. For example, interfaces such as Distributed Component Object Model (DCOM), Remote Procedure Call (RPC), or Java Remote Method Invocation (RMI) could be used instead of WBEM. However, these interfaces need the support of a driver. It is intended that the following claims be interpreted to embrace all such variations and modifications.

What is claimed is:

1. A computer system, comprising:
a processor;
a system memory coupled to the processor, the system memory stores a multi-platform management interface that, when executed, enables communication between the computer system and an updating computer; and
a Basic Input/Output System (BIOS) memory coupled to the processor, the BIOS memory stores a BIOS image and function calls compatible with the multi-platform management interface,
wherein at least one of the function calls is selectively initiated to update the BIOS image based on communication with the updating computer via the multi-platform management interface.

2. The computer system of claim 1 wherein the multi-platform management interface comprises a Web-Based Enterprise Management (WBEM) interface.

3. The computer system of claim 1 wherein the multi-platform management interface comprises a Windows Management Instrumentation (WMI) interface.

4. The computer system of claim 1 wherein a portion of the system memory is reserved during each Power On Self-Test (POST) of the computer system for storing a BIOS image update.

5. The computer system of claim 4 wherein the portion of the system memory is reserved based on at least one of an INT 15 E820 interrupt and an operation region defined by Advanced Configuration and Power Interface (ACPI) code.

6. The computer system of claim 1 wherein at least one of the function calls enables a portion of the system memory to be reserved for storing a BIOS image update in response to a request to update the BIOS image.

7. The computer system of claim 1 wherein at least one of the function calls enables a portion of the system memory to be virtually hot unplugged from the system memory for storing a BIOS image update.

8. The computer system of claim 7 wherein at least one of the function calls enables the portion of the system memory to be virtually hot plugged into the system memory after the BIOS image is updated.

9. The computer system of claim 1 wherein the function calls are associated with Advanced Configuration and Power Interface (ACPI) methods by a mapper driver.

10. A method, comprising:
storing function calls in a Basic Input/Output System (BIOS), the function calls being compatible with a multi-platform management interface
receiving a request to update a BIOS image of the BIOS via the multi-platform management interface; and
updating the BIOS image using the function calls.

11. The method of claim 10 further comprising reserving memory to store a BIOS image update during each Power On Self-Test (POST) of a computer.

12. The method of claim 10 further comprising initiating at least one of the function calls to virtually hot unplug memory space of a system memory to store a BIOS image update.

13. The method of claim 12 further comprising initiating at least one of the function calls to virtually hot plug the memory space into the system memory after updating the BIOS image.

14. The method of claim 10 wherein receiving a request to update a BIOS image of the BIOS via the multi-platform management interface comprises receiving the request from a remote computer.

15. The method of claim 10 further comprising associating each of the function calls to an Advanced Configuration and Power Interface (ACPI) method.

16. The method of claim 10 wherein updating the BIOS image using the function calls comprises generating a System Management Interrupt (SMI) routine to flash the BIOS image.

17. A system, comprising:
means for reserving a memory space to store a BIOS image update; and
means for buffering the BIOS image update to the memory space based on a multi-platform management interface.

18. The system of claim 17 further comprising means for freeing the memory space after the BIOS image is updated.

19. The system of claim 17 further comprising means for determining if the entire BIOS image update is buffered to the memory space and is valid.

20. The system of claim 17 further comprising means for selectively requesting to update the BIOS image via the multi-platform management interface.
